(19) United States
(12) Patent Application Publication
(10) Pub. No.: US 2017/0317640 A1
(43) Pub. Date: Nov. 2, 2017

(54) ARRANGEMENT FOR ANGULARLY DISPLACING SOLAR PANELS

(71) Applicant: MAHINDRA SUSTEN PVT. LTD., Worli Mumbai (IN)

(72) Inventors: Pankaj Ashok SANAP, Thane (IN); Sandeep Jayawant BHOSALE, Navi Mumbai (IN); Ashok Kumar JAIN, Thane (W) (IN); Basant Kumar JAIN, Bhandup (W) Mumbai (IN)

(21) Appl. No.: 15/498,708

(22) Filed: Apr. 27, 2017

(30) Foreign Application Priority Data
Apr. 27, 2016 (IN) 201621014681

(51) Int. Cl. H02S 20/32; F24J 2/54

(52) U.S. Cl. CPC H02S 20/32; F24J 2/541

(57) ABSTRACT

The present disclosure relates to the field of solar tracking systems. In particular, the present disclosure relates to an arrangement for angularly displacing solar panels. In accordance with the present disclosure, the arrangement angularly displaces and tracks plurality of solar panels together. Furthermore, the arrangement envisaged in the present disclosure is not complex and expensive and also requires less power during operation and less maintenance. The primary application of the arrangement envisaged in the present disclosure is in solar tracking systems.

### FIELD

The present disclosure relates to the field of solar tracking systems.

### BACKGROUND

Solar panels are typically mounted on vertical posts for trapping sunlight and converting sunlight to energy. Such mounting arrangement is generally found in areas where abundant sunlight is available. However, due to the rotational and revolution movement of the earth, the solar panels are required to be aligned with respect to the sun and the alignment is done with respect to the time of the day and the day of the year and the latitude and longitude of the place where the solar panels are fixed. Angular displacement of the solar panels are required during the day to track the apparent movement of the sun so that the sun's rays are roughly perpendicular to the surface of the solar panels for optimally capturing the maximum solar energy in the solar panels. Complex and expensive arrangements for angularly displacing and tracking solar panels for capturing the maximum solar energy have been suggested which require elaborate tooling for the manufacture and assemblage and also need continuous maintenance.

Also, conventional arrangements are not configured to move large arrays with multiple rows of solar panels. A plurality of solar panels is typically mounted at the same level with one another on top of support structures with minimal spacing between them. This economizes on space and maximizes solar collection efficiency. Rotating such large arrays with multiple rows of solar panels has become an important and necessary part of generation of solar power in large amount.

Therefore, there is a need for developing an arrangement of a solar tracking unit for angularly displacing, and tracking multiple solar panels together during the day which should limit the aforementioned drawbacks.

### OBJECTS

Some of the objects of the present disclosure, which at least one embodiment herein satisfies, are as follows.

It is an object of the present disclosure to ameliorate one or more problems of the prior art or to at least provide a useful alternative.

An object of the present disclosure is to provide an arrangement of a solar tracking unit for angularly displacing and tracking plurality of solar panels together.

Another object of the present disclosure is to provide an arrangement of a solar tracking unit that is not complex and expensive.

Still another object of the present disclosure is to provide an arrangement of a solar tracking unit that requires less power during operation and less maintenance.

Other objects and advantages of the present disclosure will be more apparent from the following description, which is not intended to limit the scope of the present disclosure.

### SUMMARY

The present disclosure envisages an arrangement for angularly displacing at least one solar panel. The arrangement comprises a first support column that extends upwards from the ground. A second support column is rotatably mounted on an operative top end of the first support column. The at least one solar panel is mounted on the second support column. A lever arm extends from the second column. A linear actuator is supported on the first column and is connected to a free end of the lever arm, wherein the extension and retraction of the linear actuator angularly displaces the lever arm, thereby causing angular displacement of the second support column and the at least one solar panel mounted on the second column.

In an embodiment, the arrangement further includes a motor to facilitate the extension and retraction of the linear actuator, wherein the motor is mounted at a distal end of the linear actuator.

In another embodiment, the lever arm is connected to the second support column via a mounting bracket.

In another embodiment, the linear actuator is selected from a group consisting of rack and pinion arrangement, worm gear arrangement, hydraulic cylinder, pneumatic cylinder, and any combinations thereof.

In another embodiment, the arrangement further includes an auxiliary solar panel for powering the motor.

In another embodiment, the second support column has a square cross section. In another embodiment, the arrangement further includes a bearing to facilitate rotatable mounting of the second support column on the first support column.

In an embodiment, the angular displacement of the second support column ranges from 0° to 300°.

### BRIEF DESCRIPTION OF DRAWING

An arrangement of a solar tracking unit for angularly displacing and tracking the solar panels, of the present disclosure will now be described with the help of an accompanying drawing, in which:

FIG. 1 illustrates a perspective view of the arrangement of the solar tracking unit for angularly displacing and tracking the solar panels, in accordance with an embodiment of the present disclosure;

FIG. 2A illustrates a schematic view of a first position of the arrangement of the solar tracking unit illustrated in FIG. 1;

FIG. 2B illustrates a schematic view of a second position of the arrangement of the solar tracking unit illustrated in FIG. 1; and

FIG. 2C illustrates a schematic view of a third position of the arrangement of the solar tracking unit illustrated in FIG. 1.

### DETAILED DESCRIPTION

Solar panels are typically mounted on vertical posts for trapping sunlight and converting sunlight to energy. Such mounting arrangement is generally found in areas where abundant sunlight is available. However, due to the rotational and revolution movement of the earth, the solar panels are required to be aligned with respect to the sun and the alignment is done with respect to the time of the day and the day of the year and the latitude and longitude of the place where the solar panels are fixed. Angular displacement of the solar panels are required during the day to track the apparent movement of the sun so that the sun's rays are roughly perpendicular to the surface of the solar panels for optimally capturing the maximum solar energy in the solar panels. Complex and expensive arrangements for angularly displacing and tracking solar panels for capturing maximum solar energy have been suggested which require elaborate tooling for the manufacture and assemblage and also need continuous maintenance.

Also, conventional arrangements are not configured to move large arrays with multiple rows of solar panels. A plurality of solar panels is typically mounted at the same level with one another on top of support structures with minimal spacing between them. This economizes on space and maximizes solar collection efficiency. Rotating such large arrays with multiple rows of solar panels has become an important and necessary part of generation of solar power in large amount. A need for developing an arrangement of a solar tracking unit for angularly displacing and tracking multiple solar panels to limit the aforementioned drawbacks therefore exists.

In order to overcome the aforementioned drawbacks, the present disclosure envisages an arrangement for angularly displacing a plurality of solar panels. The arrangement comprises a first support column (interchangably referred to as vertical post) that extends upwards from the ground. A second support column (interchangably referred to as torque tube) is rotatably mounted on an operative top end of the first support column. The at least one solar panel is mounted on the second support column. A lever arm extends from the second column. A linear actuator is supported on the first column and is connected to a free end of the lever arm, wherein the extension and retraction of the linear actuator angularly displaces the lever arm, thereby causing angular displacement of the second support column and the at least one solar panel mounted on the second column. The extension and retraction of the linear actuator is typically facilitated by a motor, which is mounted at a distal end of the linear actuator.

In accordance with the present disclosure, the lever arm is connected to the second support column via a mounting bracket.

In accordance with the present disclosure, the linear actuator is selected from a group consisting of rack and pinion arrangement, worm gear arrangement, hydraulic cylinder, pneumatic cylinder, and any combinations thereof.

In accordance with the present disclosure, the arrangement further includes an auxiliary solar panel for powering the motor.

In accordance with the present disclosure, the second support column has a square cross section, which is supported in a bearing to facilitate rotatable mounting of the second support column on the first support column. The angular displacement of the second support column ranges from 0° to 300°.

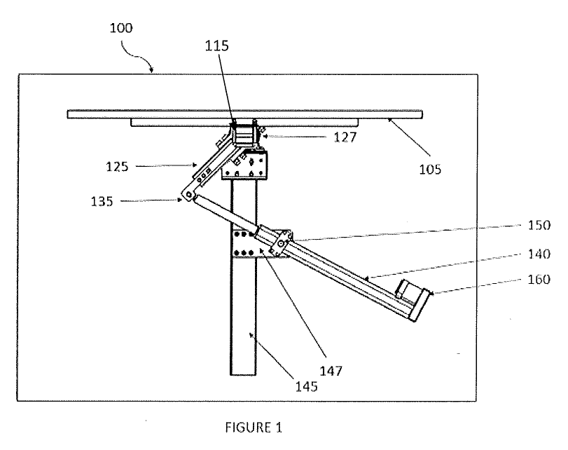

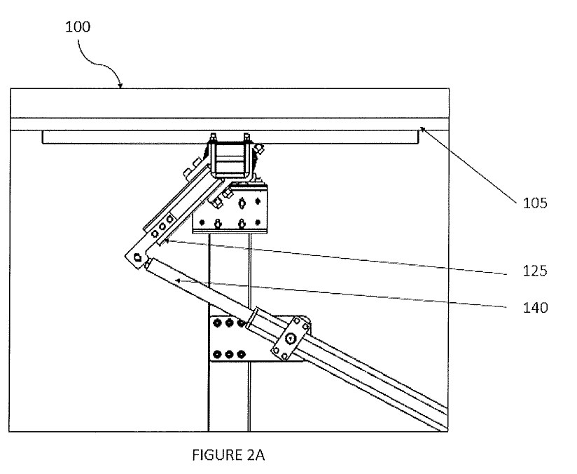

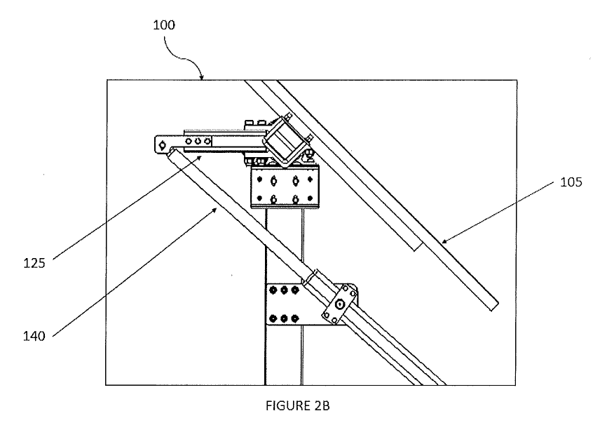

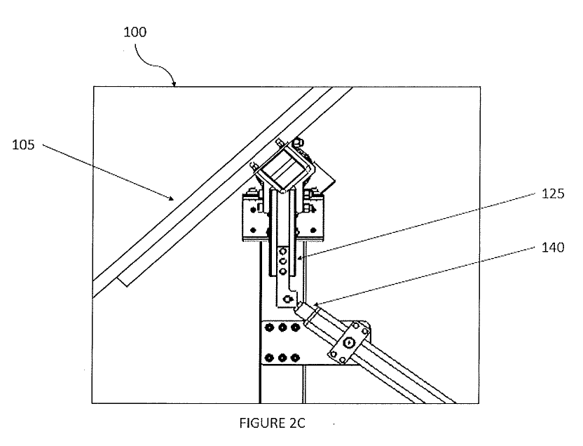

The present disclosure envisages an arrangement of a solar tracking unit for angularly displacing and tracking the solar panels, which will now be described with reference to the accompanying embodiments, illustrated in FIG. 1 through FIG. 2C, which do not limit the scope and ambit of the disclosure. The description provided is purely by way of example and illustration.

FIG. 1 illustrates a perspective view of the arrangement of the solar tracking unit 100 for angularly displacing and tracking the solar panels, in accordance with an embodiment of the present disclosure. The arrangement of the solar tracking unit 100 may comprise at least one solar panel 105, a torque tube 115, a lever arm 125, a first pivot point 135, a linear actuator 140, a vertical post 145, a base structure 147, a pivot mount 150, and a motor 160. The number of solar panels and fasteners do not limit the scope and ambit of the present disclosure and can be one or more than one. The shape and size of the torque tube, the linear actuator or the lever arm also do not limit the scope and ambit of the present disclosure.

In accordance with FIG. 1, the at least one solar panel 105 of the solar tracking unit 100 is coupled to the torque tube 115 via rails, typically C-channel or Hat section rails (not shown in the figure). A bearing (not shown in the figures) disposed over the vertical post 145 provides a passage for the torque tube 115 and is configured to hold the torque tube 115, typically a square torque tube 115, within the passage. The lever arm 125 of the solar tracking unit 100 is fixedly coupled to the torque tube 115 proximal to the bearing via a mounting bracket 127. The mounting bracket 127 is provided at an operative end of the lever arm 125 and is configured to fixedly hold the torque tube 115 therewithin. In one embodiment, the torque tube 115 is fixedly held within the mounting bracket 127 by means of a first set of fasteners (not shown in the figure). In another embodiment, the lever arm 125 is fixedly connected to the mounting bracket 127 by means of a second set of fasteners (not shown in the figure). In another embodiment, the fastener(s) used to connect mounting bracket 127 with the torque tube 115 and to connect the lever arm 125 with the mounting bracket 127 can be selected from the group consisting of screws, nuts and bolts, and the like. In one embodiment, the lever arm 125 can be made integral with the mounting bracket 127 by means of welding.

The lever arm 125 extends away from the mounting bracket 127 such that the free end of the lever arm 125 is pivotally connected to the linear actuator 140 at the first pivot point 135. The linear actuator 140 and the lever arm 125 are pivoted by means of a fastener. In an embodiment, the fastener(s) can be selected from the group consisting of screws, nuts and bolts, and the like. The body of the linear actuator 140 can be fitted to the vertical post 145 by means of the base 147 via the pivot mount 150. The motor 160 can be fitted at the distal end of the linear actuator 140. In one embodiment, the linear actuator 140 may comprise a worm or worm gear arrangement or a rack and pinion arrangement. The linear actuator 140 is configured to contract and expand depending on the rotation of the motor shaft (not shown in the figure) of the motor 160. The contraction and expansion of the linear actuator 140 results in angular displacement of the lever arm 125. Since the lever arm 125 is fixedly coupled to the torque tube 115, therefore the angular displacement of the lever arm 125 results in the angular displacement of the torque tube 115, thereby rotating the solar panels 105 mounted thereon. In one embodiment, the square torque tube 115 can be angularly displaced within the bearing through an arc typically of 300 degrees.

The contraction and expansion of the linear actuator 140 takes place in accordance with the calculations made to align the solar panels 105 with respect to the sun by angularly displacing the solar panels 105. The angular displacement of the solar panels 105 is achieved during the day to track the apparent movement of the sun so that the sunrays are roughly perpendicular to the surface of the solar panels 105 for optimally capturing the maximum solar energy in the solar panels 105.

Typically the motor 160 is connected to an auxiliary solar panel (not shown in the figure) that generates between 40 to 80 watts of energy while the motor 160, typically a DC motor operates on 24V/0.1A-3A power supply. In one embodiment, an electronic control device may be fitted between the auxiliary solar panel and the motor 160. This control device may comprise a power source and may be equipped with a battery backup and a switching assembly which may ensure that the motor 160 is driven even if the auxiliary solar panel temporarily stops supplying power because of an obstruction in the sky such as cloud formation. In another embodiment, the control device may comprise a controller that may be connected to a central command, which can feed data signals to a receiver for adjusting the movement of the linear actuator 140.

The FIGS. 2A, 2B and 2C show the different positions of the linear actuator 140, the lever arm 125 and the solar panel 105 relative to each other. These positions are constantly altered and fixed because of the requirement for tracking of the sun during the course of the day from sunrise to sunset. The FIG. 2A depicts a first position of the linear actuator 140 where the surface of the solar panel 105 makes a 90 degrees angle approximately with the rays of the sun. The FIGS. 2B and 2C shows the altered positions including a second position and a third position of the linear actuator 140 that maintain a 90 degrees angle between the surface of the solar panel 105 and the sun-rays in accordance with the position of the sun at different times of the day.

### Technical Advances and Economical Significance

The arrangement of a solar tracking unit of the present disclosure described herein above has several technical advantages including but not limited to the realization of an arrangement:

that angularly displaces and tracks plurality of solar panels together;

that is not complex and expensive; and

that requires less power during operation and less maintenance.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles or the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The embodiments herein and the various features and advantageous details thereof are explained with reference to the non-limiting embodiments in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

While considerable emphasis has been placed herein on the components and component parts of the preferred embodiments, it will be appreciated that many embodiments can be made and that many changes can be made in the preferred embodiments without departing from the principles of the disclosure. These and other changes in the preferred embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. An arrangement (100) for angularly displacing at least one solar panel (105), said arrangement (100) comprising:
a first support column (145) extending upwards from the ground;
a second support column (115) rotatably mounted on an operative top end of said first support column (145);
said at least one solar panel (105) mounted on said second support column (115);
a lever arm (125) extending from said second column; and
a linear actuator (140) supported on said first column (145), said linear actuator (140) connected to a free end of said lever arm (125), wherein the extension and retraction of said linear actuator (140) angularly displaces said lever arm, thereby causing angular displacement of said second support column (115) and said at least one solar panel (105) mounted on said second column.

2. The arrangement (100) as claimed in claim 1, which includes a motor (160) to facilitate the extension and retraction of said linear actuator (140).

3. The arrangement (100) as claimed in claim 2, wherein said motor (160) is mounted at a distal end of said linear actuator (140).

4. The arrangement (100) as claimed in claim 1, wherein said lever arm (125) is connected to said second support column (115) via a mounting bracket (127).

5. The arrangement (100) as claimed in claim 1, wherein said linear actuator (140) is selected from a group consisting of rack and pinion arrangement, worm gear arrangement, hydraulic cylinder, pneumatic cylinder, and any combinations thereof.

6. The arrangement (100) as claimed in claim 2, which includes an auxiliary solar panel for powering said motor (160).

7. The arrangement (100) as claimed in claim 1, wherein said second support column (115) has a square cross section.

8. The arrangement (100) as claimed in claim 7, which includes a bearing to facilitate rotatable mounting of said second support column (115) on said first support column (145).

9. The arrangement (100) as claimed in claim 1, wherein said angular displacement of said second support column (115) ranges from 0° to 300°.
